(19) United States
(12) Patent Application Publication
(10) Pub. No.: US 2012/0025645 A1
(43) Pub. Date: Feb. 2, 2012

(54) ELECTRIC STARTER MOTOR

(76) Inventors: Po Wah CHAN, Hong Kong (CN); Kam Sum Wong, Hong Kong (CN); Yong Zhou, Shenzhen (CN)

(21) Appl. No.: 13/196,097

(22) Filed: Aug. 2, 2011

(30) Foreign Application Priority Data
Aug. 2, 2010 (CN) 201010250323.8

(51) Int. Cl. H02K 7/116

(52) U.S. Cl. 310/83

(57) ABSTRACT

An electric starter motor for an internal combustion engine includes a rotatable output axle, a driving member mounted around the output axle, an output gear rotatably mounted around the output axle, and a friction member sandwiched between the output gear and the driving portion of the driving member. The output gear is slidable along the output axle. The hub of the driving member extends through the friction member and into the output gear.

### CROSS REFERENCE TO RELATED APPLICATIONS

This non-provisional patent application claims priority under 35 U.S.C. §119(a) from Patent Application No. 201010250323.8 filed in The People's Republic of China on Aug. 2, 2010.

### FIELD OF THE INVENTION

This invention relates to an electric starter motor used for starting an internal combustion engine, such as a gasoline engine, a diesel engine and the like.

### BACKGROUND OF THE INVENTION

A starter for an engine typically includes an output axle driven by an electric motor, an output gear, a driving plate, and an elastic friction member all directly mounted on the output axle. The driving plate is movable along the output axle. The friction member is located between the driving plate and the output gear. The driving plate defines screw threads in mesh with screw threads defined on the output axle, such that the driving plate moves along the output axle when the output axle rotates, and the driving plate thus urges the friction member and transmit the torque to the output gear via the friction member. However, lubrication oil filled in the gap between the driving plate and the output axle is liable to leak to the friction member, impairing performance of the friction member. As a result, the torque of the output axle can not be transmitted to the output gear efficiently.

Therefore, there is a need in the art to provide an improved starter for engine which can overcome the above described shortcomings.

### SUMMARY OF THE INVENTION

Accordingly, in one aspect thereof, the present invention provides a starter motor for an engine, the starter motor comprising a rotatable output axle; a driving member mounted around the output axle, the driving member comprising a hub mounted around the output axle with screw threads, and a driving portion extending radially from the hub; an output gear rotatably mounted around the output axle, the output gear being movable along the output axle; and a friction member sandwiched between the output gear and the driving portion of the driving member, wherein the hub of the driving member extends through the friction member and into the output gear.

Preferably, the starter motor further comprises a pressure spring abutting the output gear and urging the output gear against the friction member.

Preferably, the hub of the driving member extends into a first central hole of the output gear and supports the output gear.

Preferably, the first central hole is defined in one end of the output gear, the output gear further defines a second central hole in an opposite end, the first central hole communicates with the second central hole, and the first central hole has a diameter larger than that of the second central hole.

Preferably, the hub of the driving member contacts an inner surface of the output gear corresponding to the first central hole, and the output axle contacts an inner surface of the output gear corresponding to the second central hole.

Preferably, the hub defines a plurality of screw threads along all the length of the inner surface in mesh with screw threads defined on an outer surface of the output axle.

Preferably, the friction member is annular.

Preferably, the driving portion of the driving member, the friction member and the output gear have a substantially same maximal overall diameter.

According to a second aspect, the present invention also provides a starter motor, comprising a rotatable output axle with a plurality of first screw threads defined on an outer periphery; a driving member mounted around the output axle, the driving member comprising a hub defining a plurality of second screw threads on an inner surface, and a driving portion, wherein the second screw threads are in mesh with the first screw threads of the output axle; an output gear rotatably mounted around the output axle, the output gear being movable along the output axle; and a friction member mounted around the hub of the driving member and in friction contact with the output gear and the driving portion of the driving member, wherein the hub of the driving member extends through the friction member and into the output gear.

Preferably, the starter motor further comprises a pressure spring abutting the output gear and urging the output gear against the friction member.

Preferably, the hub of the driving member extends into a first central hole of the output gear and supports the output gear.

Preferably, the first central hole is defined in one end of the output gear, the output gear further defines a second central hole in an opposite end, the first central hole communicates with the second central hole, and the first central hole has a diameter larger than that of the second central hole.

Preferably, the hub of the driving member contacts an inner surface of the output gear corresponding to the first central hole, and the output axle contacts an inner surface of the output gear corresponding to the second central hole.

Preferably, the second screw threads are defined along all the length of the inner surface of the hub.

### BRIEF DESCRIPTION OF THE DRAWINGS

Preferred embodiments of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 is an assembled, isometric view of a starter in accordance with an exemplary embodiment of the present invention;

FIG. 2 is an isometric view of an output axle of the starter of FIG. 1;

FIG. 3 shows a relationship of the output axle and a driving member of the starter of FIG. 1;

FIG. 4 shows a relationship of the output axle, the driving member and a friction member of the starter of FIG. 1;

FIG. 5 shows a relationship of the output axle, the driving member, the friction member and an output'gear of the starter of FIG. 1;

FIG. 6 shows a relationship of the output axle, the driving member, the friction member, the output gear, and a pressure spring of the starter of FIG. 1; and

FIG. 7 is a cross section of an assembly of the driving member, the friction member, and the output gear of the starter of FIG. 1.

### DETAILED DESCRIPTION OF THE PREFERRED EMBODIMENTS

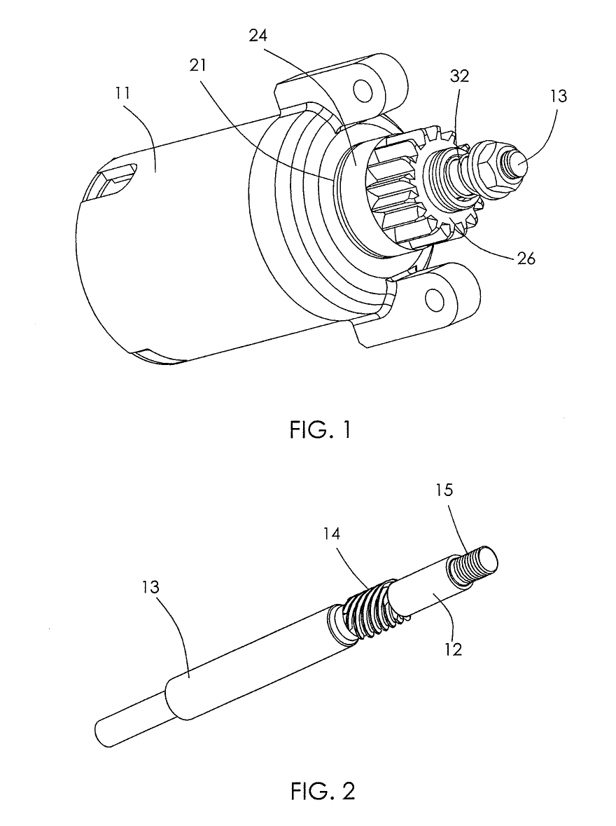

Referring to FIG. 1, the starter for an engine includes an output axle 13 driven by a motor 11, a driving member 21 mounted around the output axle 13, an output gear 26 movably mounted around the output axle 13, a friction member 24 located between the driving member 21 and the output gear 26, a pressure spring 32 abutting against the output gear 26 so as to urge the output gear 26 against the friction member 24. The friction member 24 is pressed between and in friction contact with the driving member 21 and the output gear 26.

When the starter starts to rotate, the driving member 21 driven by the rotating output axle 13 moves along the output axle 13, and pushes against the friction member 24. The friction member 24, in turn, presses against the output gear 26, to move the output gear 26 to a working position, where the output gear 26 engages with a flywheel of the engine. After the output gear 26 has engaged the flywheel, the output gear 26 stops moving along the output axle 13. As the output axle 13 continues rotating, the driving member 21 which has a tendency to move towards the output gear 26 continues to press against the friction member 24, increasing friction forces between the friction member 24 and both the driving member 21 and the output gear 26. When the friction forces reach a certain value, the friction member 24 and the output gear 26 rotate with the driving member 21. Therefore, the torque of the output axle 13 is transmitted to the output gear 26 via the driving member 21 and the friction member 24, to thereby drive the engine.

Referring to FIG. 2, the output axle 13 includes a thin portion 12 at an axial end. The thin portion 12 has a smaller diameter than the other portion of the output axle 13, for mounting the driving member 21, the friction member 24, the output gear 26, and the pressure spring 32 thereon. More specifically, the thin portion 12 of the output axle 13 defines a plurality of male screw threads 14 at one fixed end for mounting the driving member 21 thereon. An opposite free end of the thin portion 12 defines a plurality of fine screw threads 15 for mounting a nut 31 thereon (see FIG. 6). One end of the pressure spring 32 urges the nut 31 via a washer, and the other end of the pressure spring 32 abuts against and urges the output gear 26. The output axle 13 can be a shaft of a motor, or an output shaft of a gear driven by a motor.

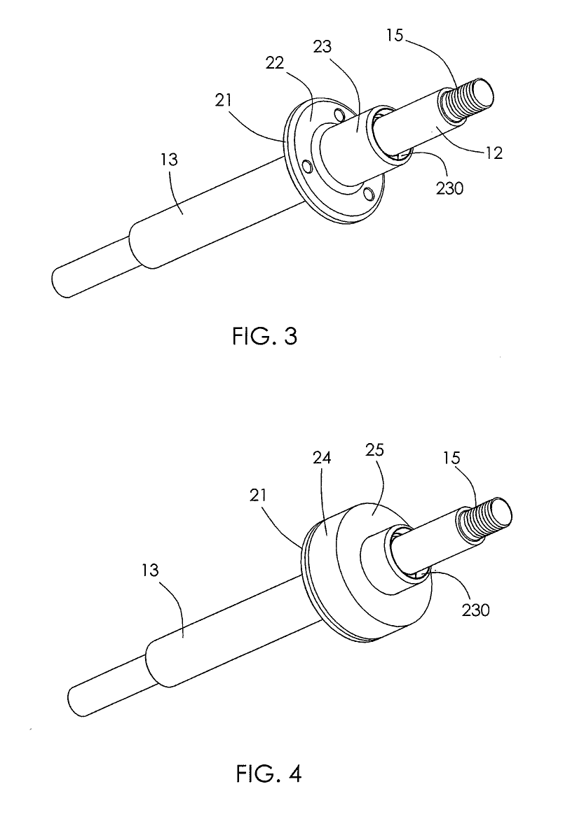

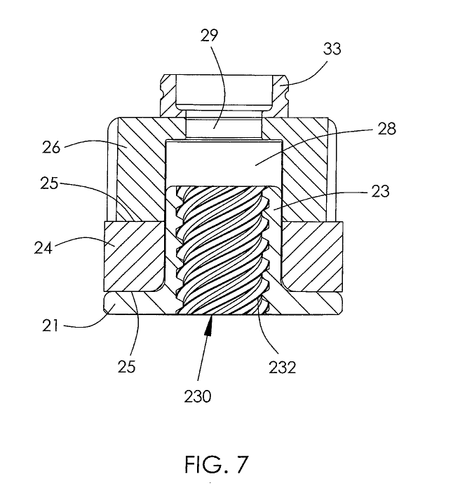

Referring to FIG. 3, the driving member 21 includes a hub 23 and a driving portion 22 extending radially from the hub 23. The hub 23 is cylindrical, and the driving portion 22 is disc-shaped. The hub 23 defines a central hole 230 there through for allowing the output axle 13 to extend through. A plurality of female screw threads 232 (see FIG. 7) meshing with the male screw threads 14 of the output axle 13 is defined in an inner surface of the hub 23 surrounding the central hole 230. Alternatively, the female screw threads 232 can be defined on the output axle 13, and correspondingly, the male screw threads 14 are defined in the hub 23 of the driving member 21. The driving member 21 is mounted around the output axle 13, with the output axle 13 extending through and in mesh with the hub 23. Lubricant oil is filled in a gap between the output axle 13 and the hub 23 of the driving member 21, so as to facilitate the movement of the driving member 21 along the output axle 13.

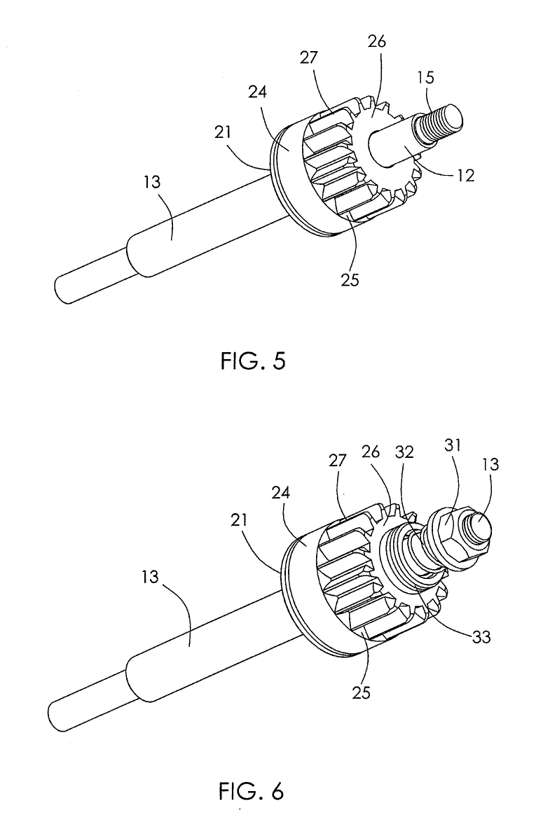

Referring to FIG. 4, the friction member 24 is annular, and mounted around the hub 23 of the driving member 21. The friction member 24 has two opposite contact surfaces 25 for contacting the driving portion 22 of the driving member 21 and the output gear 26 (see FIG. 5), respectively. The hub 23 of the driving member 21 extends through the contact surfaces 25, such that the lubricant oil between the hub 23 of the driving member 21 and the output axle 13 is prevented from leaking to the friction member 24. Accordingly, the friction member 24 is protected from contamination. Preferably, the friction member 24 is made of rubber, such as nitrile butadiene rubber and the like.

Referring to FIGS. 5-7, the output gear 26 is mounted around the output axle 13, with the friction member 24 sandwiched between the output gear 26 and the driving portion 22 of the driving member 21. The output gear 26 has a plurality of teeth 27 circumferentially spaced at an outer periphery for engaging with the flywheel of the engine. The output gear 26 defines a first central hole 28 at one end adjacent to the friction member 24, and a second central hole 29 at an opposite end. The second central hole 29 communicates with the first central hole 28. The first central hole 28 has a diameter larger than that of the second hole 29. The diameter of the first central hole 28 is substantially the same as an outer diameter of the hub 23 of the driving member 21. The diameter of the second hole 29 is substantially the same as an outer diameter of the thin portion 12 of the output axle 13.

The thin portion 12 of the output axle 13 is fittingly received in the second central hole 29 of the output gear 26, contacting an inner surface of the output gear 26 corresponding to the second central hole 29. A free end of the hub 23 of the driving member 21 extends into the first central hole 28 of the output gear 26, and the hub 23 of the driving member 21 contacts an inner surface of the output gear 26 corresponding to the first central hole 28. As the hub 23 of the driving member extends into the first central hole 28 of the output gear 26, the lubricant oil is prevented from leaking to the friction member 24. In addition, the output gear 26 is supported by both the hub 23 and the output axle 13, avoiding an offset between an axis of the output gear 26 and the output axle 13, which may result in disengagement of the output gear 26 and the flywheel of the engine. Furthermore, the output gear 26 supported by both the hub 23 of the driving member 21 and the output axle 13 can rotate smoothly.

Preferably, the female screw threads are defined along all the length of the inner surface of the hub 23, so as to ensure a coaxiality of the hub 23 of the driving member 21 and the output axle 13, and accordingly a coaxiality of the output gear 26 and the output axle 13 is ensured.

Referring to FIGS. 6 and 7, the pressure spring 32 is located between the nut 31 and the output gear 26. One end of the pressure spring 32 bears against the nut 31 via a washer, and the other end of the pressure spring 32 bears against the output gear 26 via a spring seat 33 and urges the output gear against the friction member 24. Thus, the friction member 24 is always pressed between the driving member 21 and the output gear 26.

In this embodiment, the driving member 21, the friction member 24 and the output gear 26 are independent components, and the driving portion 22 of the driving member 21, the friction member 24 and the output gear 26 have a substantially same maximal overall diameter. Alternatively, the driving portion of the driving member 21 may be received in the friction member 24. Further, the friction member 24 may be integrally formed with one of the driving member 21 and the output gear 26, for example, by insert molding.

Although the invention is described with reference to one or more preferred embodiments, it should be appreciated by those skilled in the art that various modifications are possible. Therefore, the scope of the invention is to be determined by reference to the claims that follow.

In the description and claims of the present application, each of the verbs “comprise”, “include”, “contain” and “have”, and variations thereof, are used in an inclusive sense, to specify the presence of the stated item but not to exclude the presence of additional items.

1. An electric starter motor for an internal combustion engine, the starter motor comprising:
a rotatable output axle;
a driving member mounted around the output axle, the driving member comprising a hub mounted around the output axle with screw threads, and a driving portion extending radially from the hub;
an output gear rotatably mounted around the output axle, the output gear being movable along the output axle; and
a friction member sandwiched between the output gear and the driving portion of the driving member, wherein the hub of the driving member extends through the friction member and into the output gear.

2. The starter motor of claim 1, further comprising a pressure spring abutting the output gear and urging the output gear against the friction member.

3. The starter motor of claim 1, wherein the hub of the driving member extends into a first central hole of the output gear and supports the output gear.

4. The starter motor of claim 3, wherein the first central hole is defined in one end of the output gear, the output gear further defines a second central hole in an opposite end, the first central hole communicates with the second central hole, and the first central hole has a diameter larger than that of the second central hole.

5. The starter motor of claim 4, wherein the hub of the driving member contacts an inner surface of the output gear corresponding to the first central hole, and the output axle contacts an inner surface of the output gear corresponding to the second central hole.

6. The starter motor of claim 1, wherein the hub defines a plurality of screw threads along all the length of the inner surface in mesh with screw threads defined on an outer surface of the output axle.

7. The starter motor of claim 1, wherein the friction member is annular.

8. The starter motor of claim 7, wherein the driving portion of the driving member, the friction member and the output gear have a substantially same maximal overall diameter.

9. An electric starter motor for an internal combustion engine, the starter motor comprising:
a rotatable output axle with a plurality of first screw threads defined on an outer periphery;
a driving member mounted around the output axle, the driving member comprising a hub defining a plurality of second screw threads on an inner surface, and a driving portion, wherein the second screw threads are in mesh with the first screw threads of the output axle;
an output gear rotatably mounted around the output axle, the output gear being movable along the output axle; and
a friction member mounted around the hub of the driving member and in friction contact with the output gear and the driving portion of the driving member, wherein the hub of the driving member extends through the friction member and into the output gear.

10. The starter motor of claim 9, further comprising a pressure spring abutting the output gear and urging the output gear against the friction member.

11. The starter motor of claim 9, wherein the hub of the driving member extends into a first central hole of the output gear and supports the output gear.

12. The starter motor of claim 11, wherein the first central hole is defined in one end of the output gear, the output gear further defines a second central hole in an opposite end, the first central hole communicates with the second central hole, and the first central hole has a diameter larger than that of the second central hole.

13. The starter motor of claim 12, wherein the hub of the driving member contacts an inner surface of the output gear corresponding to the first central hole, and the output axle contacts an inner surface of the output gear corresponding to the second central hole.

14. The starter motor of claim 9, wherein the second screw threads are defined along all the length of the inner surface of the hub.
